(19) United States
(12) Patent Application Publication
(10) Pub. No.: US 2003/0139134 A1
(43) Pub. Date: Jul. 24, 2003

(54) Architecture of an IP utility network enabling smart homes, smart commercial buildings, smart residential communities

(76) Inventors: David L. Bailey, Farmington, UT (US); Paul D. Losee, Layton, UT (US); George E. Demorest, Fruit Heights, UT (US)

Correspondence Address: Philip M. Weiss, Weiss & Weiss, 310 Old Country Road, Garden City, NY, 11530, US

(21) Appl. No.: 10/349,400

(22) Filed: Jan. 22, 2003

Related U.S. Application Data
(60) Provisional application No. 60/350,659, filed on Jan. 22, 2002.
(60) Provisional application No. 60/350,874, filed on Jan. 22, 2002.
(60) Provisional application No. 60/350,658, filed on Jan. 22, 2002.
(60) Provisional application No. 60/350,548, filed on Jan. 22, 2002.

(51) Int. Cl. H04H 1/00

(52) U.S. Cl. 455/3.01; 455/3.06

(57) ABSTRACT

An IP utility network that enables smart homes, smart commercial buildings and smart residential communities.

### FIELD OF THE INVENTION

The present invention relates to the architecture of an IP utility network that enables smart homes, smart commercial buildings, and smart residential communities.

### BACKGROUND OF THE INVENTION

At the present time, two trillion dollar industries, voice and data are merging. With the advent of Voice over Internet Protocol technology (VoIP), voice is converted to data and delivered over upgraded data networks enabled with higher Quality of Service (QOS) standards.

VoIP is now recognized by both the data and voice industries as the new standard protocol for voice. Nearly 100% of long-haul voice traffic today is converted to VoIP and shipped across country and internationally through fiber networks.

However, inside most buildings, separate networks for voice and data still exist. Voice travels on PBX analog telephone networks and data moves on Local Area Networks (LAN's). In many businesses where video and TV are required, another completely separate network exists for this medium.

In order for voice to move over the LAN with high QOS, a new network architecture is required. The new network must accommodate packets of voice, video and data at all points on the network, the LAN, the Managed Area Network (MAN) and the Wide Area Network (WAN).

In the prior art most buildings use a local exchange carrier that provides voice solutions and data solutions to tenants. These voice and data solutions share different lines. The local exchange carrier is not integrated, not cost effective, and there is no IP network. Further there is no revenue sharing with building owners. There is no management of data packet across all three networks. The prior art does not provide the ability to consolidate multiple buildings onto a network. There is also no physical facilities management integration.

In the prior art, smart buildings were defined as (1) delivering bandwidth to the building for the transmission of only data; (2) automating controls for power, gas, fire, air conditioning and security devices; and (3) providing applications to a building in a client-server environment. While all three of these are necessary, none of them are sufficient.

In the prior art there are discrete security systems, such as closed circuit television for each building which are expensive and not interfaced with database functions. There also is a firewall protection for LAN applications which is expensive to deploy to smaller businesses and has no cross functional interface. There also exists identical systems set up in separate buildings, but communications between systems are cumbersome.

In the prior art, major carriers have provided individual tenants with data and voice applications. The problems with the prior art are no economics of scale and the tenants are locked into contracts with the carriers. Further, there is no sharing of application revenue with the building owners. The menu of applications is limited to those offered by the carrier. Missing is an application device interface allowing efficient access to the Wide Area Network (WAN).

Also tenants buy specific applications from vendors. These applications are costly on a low volume basis. There are no service and maintenance economies of scale. Tenants are generally not knowledgeable concerning the latest technology.

U.S. Pat. No. 5,778,059 relates to a distributed and event-driven processing environment for controlling a number of elements characterized by different states and events. Finite state machines are frequently used to control devices in a complex control environment such as a smart building or a telecommunications switching device. In a smart building, a number of different sensors for temperature, humidity, ambient light, occupancy and the like generate a number of different events which affect how devices such as HVAC, lighting, and security systems are controlled. Similarly, a telecommunications switching device provides a number of different services or features to various subscriber units and circuits (e.g., ports, trunks, lines and so on), which operate in various call processing states precipitated by various events. The API set represents a library of routines with which a programmer can design new functions for a system such as a building environment control or telecommunications switching system. The API set allows control and utilization of such capabilities as call detail recording, hunt groups and trunk groups, COS, memory management, switching control, tone dialing, tone decoding, timers, call pick-up groups, addressing, conferencing, fixed databases, and negotiations with other system or peer processors or external host processors.

U.S. Pat. No. 5,673,395 relates to a process for constructing computer network system of tenant intelligent building. Computer network systems in optional tenant rooms in an intelligent building are connected collectively by means of optical fiber cables and an optical patch panel, thereby providing computer network systems of every tenant independent of each other and high in safety. Optical connectors are provided in a plurality of tenant rooms installed on the respective floors of a tenant intelligent building incorporating therein enterprises different from one another. Optical fiber cables having at least four cores are connected to the optical connectors. The cables in the respective tenant rooms on the respective floors are bundled and connected to an optical patch panel provided at an appropriate place in the building. The optical fiber cables from the tenant rooms can be connected to one another through the optical patch panel by replacing the patch cords, so that independent transmission medium systems of the respective tenant are performed. In accordance with the use conditions of the tenant floors in the building, the backbone system of a desirable block (tenant rooms) on desired floors can be easily constructed merely by replacing the patch cords on the optical patch panel.

U.S. Pat. No. 5,509,108 relates to an apparatus and method for controlling a printing machine. There is provided a control apparatus for a printing machine located in a building with a portion of the building characterized by an environmental state. The printing machine includes a print machine component, while the control apparatus includes a communication line, operatively coupled with the printing machine, across which signals are transmitted. A sensing arrangement, communicating with the communication line, transmits a signal, representative of the environmental state of the building portion, across the communication line. An interface receives and converts the signal to a control signal, the control signal being used to control the print machine component. The invention relates to an arrangement that couples a printing machine with a smart building management network for maximizing the operation of the printing machine. Smart building refers to a control arrangement in which building utilities, such as lights, air conditioners, work stations, etc. are controlled by a central control system, the controller being responsive to sensed events, such as a preselected number of people entering the building or a bank of lights being turned on. In one example, the sensed event based on entering people is achieved through use of a motion sensor. In practice, each component of the smart building is coupled with a common communication link, such as the power line of the building. One type of smart building can be implemented through employment of a local operating network (LON), which LON provides a powerful tool for implementing a distributed system that performs sensory, monitoring, control and other applications.

### SUMMARY OF THE INVENTION

The present invention relates to a system that provides voice, video and data to cities, commercial buildings, condominiums, and homes. The system comprises a central location having fibers from vendors which provide Internet, Long Distance and Bandwidth to a community. The central location is connected to one or more smaller POP(s) Point of Presence. The smaller POPs provide services to smaller communities and use local carriers. The central location and smaller POPs are connected to a further POP which contains backbone network equipment. The further POP contains both hardware and software. It is an object of the present invention for the further POP to comprise an Ethernet and Vocal data. It is an object of the present invention for the further POP to manage all information that flows between the system. It is an object of the present invention for the smaller POP and central location to be connected by DS-3 lines.

The present invention relates to a method for providing Vocal, Data and Video comprising: determining where a user is making a phone call to. The call is then placed through a carrier based on best price and/or quality of service. A bill is provided to the user based on services provided to the customer.

It is an object of the present invention for the system to comprise a Content Distribution Network (CDN). It is an object of the present invention for vastly different information to be sent across fiber and copper lines in small transport units called packets. The packets are tracked and prioritized by the further POP to allow delivery of voice, video and data across a single line.

The present invention relates to the architecture of a building IP network that enables smart buildings. It is an object of the present invention for the building IP network to incorporate a Content Distribution Network (CDN). It is an object of the present invention for the building IP network to incorporate a multi provisioning platform. It is an object of the present invention for the building IP network to incorporate a Physical Facilities Platform (PFP). It is an object of the present invention for the building IP network to incorporate a Data Security Platform (DSP).

It is an object of the present invention to provide a Data Convergence Platform. It is a further object of the present invention for the building IP Network to be connected to a control center to manage multiple buildings. It is an object of the present invention to allow for a minimum amount of wiring in a building.

It is an object of the present invention for the system to be retrofitted into an existing system.

It is an object of the present invention for vastly different information to be sent across fiber and copper lines in small transport units called “packets”. These packets are tracked and prioritized by the IP Utility Network to allow delivery of voice, video and data across a single line with the required quality of service that customers require.

It is an object of the present invention to provide Quality of Service (QOS) prescribed standards for voice, video and data from packet origination to termination. It is an object of the present invention for the system to provide convergence of all voice, video and data information over a single line. It is an object of the present invention to provide connection of electronic devices at any point in the IP Utility network. It is an object of the present invention for the system to provide high speed packet based services to every user.

It is an object of the present invention for the system to control the building and home physical devices and systems such as security systems, heating, lighting, air conditioning, entertainment devices, etc. It is an object of the present invention for the system of the present invention to provide basic telephony services to users such as Local Dial Tone, Long Distance, Voice Mail, Conference Calling, and Conference Bridging. It is an object of the present invention for the system to provide basic data services including: Internet, Email, File Sharing, Data Firewall, and Virus Protection. It is an object of the present invention for the system to provide Video and TV services including: Local TV channels, Cable channels, Video on Demand (downloading movies from Blockbuster, Hollywood Video . . . ) High Definition IPTV, and Targeted Advertising. It is an object of the present invention for the system to provide new integrated voice, video and data services such as: Text to Voice, Voice to Text, On-Demand Phone Installation, Wireless Interface Services, Person Identification for Security Applications, etc. It is an object of the present invention to provide a standard interface for IP appliances to communicate effectively on the network. It is an object of the present invention for the system to provide integration of community sectors across the network; including education, residence, business and government.

It is an object of the present invention to secure the physical and data systems of a smart building. It is an object of the present invention to provide physical security to a building by using a smart card or similar personal identification process. It is an object of the present invention to provide physical security to a building by using a biometric identification process.

It is an object of the present invention for the security functions of the smart building to all be integrated. It is an object of the present invention for multiple smart buildings to be managed from one common place. It is an object of the present invention for the security system to be run on a common language to allow setting security across physical/data boundary. It is an object of the present invention for the security system to interface with database information of personnel backgrounds. It is an object of the present invention for the system to provide ambient environmental controls. It is an object of the present invention for the systems and devices to be connected to a fiber backbone network.

### BRIEF DESCRIPTION OF THE DRAWINGS

FIG. 1 is an illustration of an embodiment of the system of the present invention.

### DETAILED DESCRIPTION OF THE INVENTION

The present invention relates to the architecture of a building IP network that enables smart buildings. The present invention incorporates a Content Distribution Network (CDN). The content distribution network allows content deployment to tenants through the ASP model. The CDN system also allows revenue sharing by the building owner. Further the CDN increases the overall value of the building.

The multi provisioning platform allows multiple providers (LEC's, CLEC's) to access the tenants through the building brain. This allows tenants to share in cost advantages across different telco providers. This also allows a building owner to share in telco revenue.

The Physical facilities platform allows all building functions to talk to each other through a common language (IP). This platform allows the building owner and the tenants to save money on power, gas, HVAC, etc., through electronic management according to efficiency algorithms.

The data security platform provides security through IP cameras placed throughout a building. The platform further provides security through firewall and virus screening capability.

The Data convergence platform of the present invention provides voice, computer data, video and electrical controls.

In a preferred embodiment, the Building IP Network is connected to a control center which manages multiple buildings. This enables VoIP calling within the network at no long distance costs. The system of the present invention further enables sharing of expensive applications through ASP deployment. These applications include: data firewalls, conference bridges, video bridges, etc.

In one embodiment the Master Control Center manages the data within the LAN and from the LAN through other networks. The Master Control Center can manage access to and from any service provider. The Master Control Center manages the data to insure optimum routing for cost and efficiency. It specifically manages the voice data to insure proper termination and guaranteed quality of service through selected IP networks.

The building IP Network of the present invention allows for minimum wiring inside the building. One wire (fiber) handles all functions. This eliminates multiple vendors stringing wire and cable inside the building. Further, the building owner owns the wiring, one of the key assets of the building.

In a preferred embodiment, the basic infrastructure is compatible with long distance analog equipment. The present invention provides wireless interface capability. In a preferred embodiment, the system of the present invention provides 911 and facsimile capability.

In an embodiment, Data/Bandwidth services are provided which include fiber to each floor, GB Bandwidth to the Desktop, LAN and WAN Connectivity and Desktop Video Conferencing.

In an embodiment, the system controls the functions of the building by running fibers to the building edge and fibers to each floor of the building. Further, there is Cat 5 wiring to each desktop.

In an embodiment of the present invention, the system provides cost efficiencies to a building owner. The building owner can aggregate services, and buy in bulk from suppliers. Further, building owners can resell the applications for retail cost to tenants.

In an embodiment of the present invention, the system merges applications across electronic and physical platforms. The system of the present invention saves energy by matching building functions with database information and behavior patterns. The system allows tenants to share services. For example, a day time tenant can lease/resell bandwidth and/or phone service to a night time tenant.

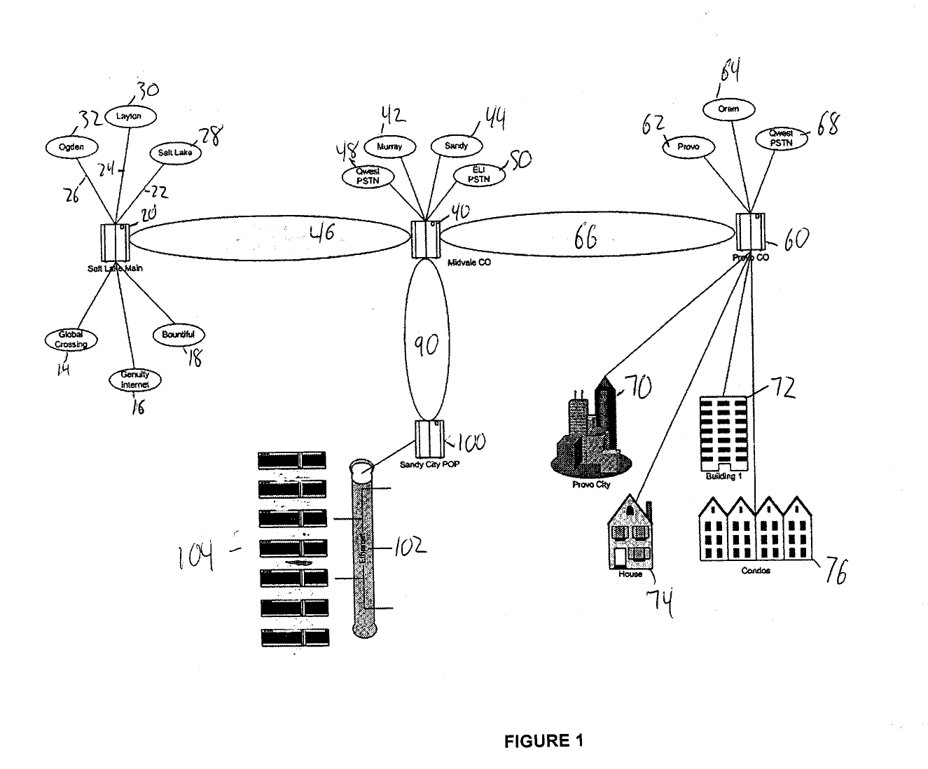

FIG. 1 shows an example of the backbone network of the present invention. In order to deliver converged voice, video and data services, the backbone network as shown in FIG. 1 is first installed. An example of the backbone network equipment is shown below.

| QTY | EQUIPMENT DESCRIPTION |
|---|---|
| 1 | 2 Port T3 Serial Port Adapter-1 |
| 1 | 2 Port T3 Serial Port Adapter-2 |
| 1 | Catalyst 6000 24 MB Flash-1 |
| 1 | Catalyst 6000 24 MB Flash-2 |
| 1 | Catalyst 6000 Chassis-1 |
| 1 | Catalyst 6000 Chassis-2 |
| 1 | Catalyst 6500 Sup Engine-1 |
| 1 | Catalyst 6500 Sup Engine-2 |
| 1 | Catalyst 6000 GBIC Blade-1 |
| 1 | Catalyst 6000 GBIC Blade-2 |
| 1 | Catalyst 6000 GBIC Blade-3 |
| 1 | Catalyst 6000 48PT 10/100 |
| 1 | Catalyst 3524-PWR XL ENT |
| 1 | Catalyst 3524 XL ENT ED |
| 1 | Gigastacking GBIC-1 |
| 1 | Gigastacking GBIC-2 |
| 1 | Catalyst 3548 XL ENT |
| 1 | Catalyst 6000 8 port Voice T1 |
| 1 | Catalyst 6000 8 port Voice T1 |
| 1 | CCM-1 |
| 1 | CCM-2 |
| 1 | CCM-3 |
| 15 | Cisco IP Phone 6 Line Display-1 |
| 4 | Cisco IP Phone 6 Line Display-2 |
| 1 | 7206VXR W/NPE-400 and IO-1 |
| 1 | 7206VXR W/NPE-400 and IO-2 |
| 1 | Catalyst Series 1000BSX GBIC MOD MMF-1 |
| 1 | Catalyst Series 1000BSX GBIC MOD MMF-2 |
| 1 | Catalyst Series 1000BSX GBIC MOD MMF-3 |
| 1 | 29″ Cabinets 26″ × 6′ W/Fan-1 |
| 1 | 29″ Cabinets 26″ × 6′ W/Fan-2 |
| 1 | 29″ Cabinets 32″ × 6′ W/Fan-3 |
| 1 | Firewall-1 |
| 1 | Firewall-2 |
| 1 | UPS-1 |
| 1 | UPS-2 |
| 1 | UPS-3 |
| 1 | Smartnet Unity |
| 1 | Smartnet CCM |
| 1 | Smartnet Unity |
| 1 | Smartnet CCM |
| 1 | Adtran 800 atlas |
| 1 | Adtran 600 atlas |
| 2 | Adtrad 600 Analog Cards |
| 2 | 2 port analog to IP box |
| 1 | Adtrad 600 Analog Cards |
| 1 | Unity Server |
| 1 | DNS Server |

Once the backbone network is established, equipment is installed at each type of location (premise equipment) that seamlessly interfaces with the backbone network to create the fully functional IP Utility Network that integrates voice, video and data and guarantees quality of services (QOS) from packet origination to termination. An example of the premise equipment for a financial business located in a smart building with 73 phones is:

Smart Building Premise Equipment (BPE)

| Quantity | Description |
|---|---|
| 6 | 10/100 Ethernet Router with 2 WIC Slots, 1 Network Module |
| | Slot |
| 6 | Catalyst 3524-PWR-XL Enterprise Edition |
| 73 | Cisco IP Phone 7940, Business Set (with User License) |

Example of equipment installed at the gateway of a smart community is:

Smart Community Premise Equipment (CPE)

12′×15′ Building Prefab

Backup generator

Fiber Single Mode Strand by feet

Fiber ends and labor

Equipment by Subscriber Trunk Side

Fiber Patch Panels 2000 Strands

Racks 7′ 21″

Install per hour

Pedestals

Quad Lock Conduit

Hand Holes

Fiber Drops

An example of the customer premise equipment required to create a smart home is:

Smart Home Premise Equipment (HPE)

Fiber ends and labor

World Wide Packets Home Term Point

Set Top Box

FIG. 1 is an example of a system that provides Voice, Video and Data to cities, commercial buildings, condominiums, and homes. The system of the present invention can be used in any metropolitan area.

In a standard system, vendors 14, 16, and 18 bring their fibers to a central location 20, which through fibers 22, 24 and 26 is connected to several cities 28, 30 and 32. These vendors provide Internet, Long Distance and Bandwidth along with other services to a central location 20. The central location 20 is connected to a smaller POP (Point of Presence) 40, which provides services to smaller communities 42 and 44. POP 40 is connected to central location 20 by 2 DS-3's 46. POP 40 is also provided with local carriers 48 and 50.

In an embodiment, POP 40 is connected to a further small POP 60 which provides services to smaller communities 62 and 64. POP 60 is connected to POP 40 through a DS-3 connection 66. POP 60 is provided with a local carrier 68. POP provides service to city 70, commercial building 72, home 74 and condominiums 76.

Central location 20, and POPs 40 and 60 are connected through pipe connection 90 to POP 100 which contains the backbone network equipment. POP 100 contains both hardware and software. POP 100 contains the Ethernet 102 and Vocal data 104. POP 100 manages all of the information that flows between the nodes.

In an example of the system of the present invention, a person picks up the phone and makes a call from a community 62. The call is determined to be a local call so it is put through the local carrier 68 rather than through the long distance carriers 14, 16, or 18. The system decides which companies to use regarding the InternetLong Distance, Band Width, etc. based on factors such as price, Quality of Service (QOS), etc. The system of the present invention bills the customer based on the services that are provided to the customer. The system manages data, voice and video.

1. A system that provides voice, video and data to cities, commercial buildings, condominiums, and homes comprising:
a central location having fibers from vendors which provide Internet, Long Distance and Bandwidth to a community;
said central location connected to one or more smaller POP(s);
said smaller POP providing services to smaller communities;
said smaller POP provided with local carriers;
said central location and smaller POPs connected to a further POP which contains backbone network equipment;
said further POP containing both hardware and software.

2. The system of claim 1 wherein said further POP comprises an Ethernet and Vocal data.

3. The system of claim 1 wherein said further POP manages all information that flows between said system.

4. The system of claim 1 wherein said smaller POP and central location are connected by DS-3 lines.

5. A method for providing Vocal, Data and Video comprising:
determining where a user is making a phone call to;
placing said call through a carrier based on best price and/or quality of service;
providing a bill to said user based on services provided to said customer.

6. The system of claim 1 wherein said system comprises a Content Distribution Network (CDN).

7. The system of claim 1 wherein vastly different information is sent across fiber and copper lines in small transport units called packets; said packets being tracked and prioritized by said further POP to allow delivery of voice, video and data across a single line.

8. The system of claim 1 wherein said system controls said building and said home physical devices and systems including security systems, heating, lighting, air conditioning, entertainment devices, etc.

9. The system of claim 1 wherein said system provides basic telephony services to users such as Local Dial Tone, Long Distance, Voice Mail, Conference Calling, and Conference Bridging.

10. The system of claim 1 wherein said system provides basic data services including: Internet, Email, File Sharing, Data Firewall, and Virus Protection.

11. The system of claim 1 wherein said system provides Video and TV services including: Local TV channels, Cable channels, Video on Demand High Definition IPTV, and Targeted Advertising.

12. The system of claim 1 wherein said system provides integrated voice, video and data services including: Text to Voice, Voice to Text, On-Demand Phone Installation, Wireless Interface Services, Person Identification for Security Applications, etc.

13. The system of claim 1 wherein said system provides integration of community sectors across said network; including education, residence, business and government.

14. The system of claim 8 wherein said security comprises a smart card or similar personal identification process or a biometric identification process.

15. The system of claim 14 wherein said system interfaces with a database information of personnel backgrounds.

16. The system of claim 1 wherein said system provides environmental controls.
